(19) United States
(12) Patent Application Publication
(10) Pub. No.: US 2026/0290226 A1
(43) Pub. Date: Sep. 24, 2026

(54) PIXEL CIRCUIT AND METHOD FOR DRIVING THE SAME, AND DISPLAY PANEL AND DISPLAY APPARATUS

(71) Applicants: Beijing BOE Technology Development Co., Ltd., Beijing (CN); BOE Technology Group Co., Ltd., Beijing (CN)

(72) Inventors: Can WANG, Beijing (CN); Minghua XUAN, Beijing (CN); Can ZHANG, Beijing (CN); Ning CONG, Beijing (CN); Jinfei NIU, Beijing (CN); Jingjing ZHANG, Beijing (CN); Jiakui YAN, Beijing (CN)

(21) Appl. No.: 19/477,444

(22) PCT Filed: Mar. 15, 2024
(86) PCT No.: PCT/CN2024/081809

§ 371 Date: Oct. 21, 2025

(30) Foreign Application Priority Data
Apr. 25, 2023 (CN) 202310456728.4

(51) Int. Cl. G09G 3/32

(52) U.S. Cl. CPC G09G 3/32; G09G 2300/0819; G09G 2310/08; G09G 2320/0233

(57) ABSTRACT

A pixel circuit and a driving method thereof, a display panel, and a display apparatus are provided. In the pixel circuit, a first driving circuit is capable of transmitting a light emission driving signal to a first node; and a second driving circuit is capable of transmitting a light emission control signal having a target potential which is a first potential or a second potential to a second node. A light emission control circuit is capable of controlling switching on and switching off between the first node and a light-emitting component based on the light emission control signal, wherein a switching-on duration between the first node and the light-emitting component is positively correlated with an uninterrupted duration of the target potential.

The present application is a national phase application based on PCT/CN2024/081809, filed on Mar. 15, 2024, which claims priority to Chinese Patent Application No. 202310456728.4, filed on Apr. 25, 2023 and entitled “PIXEL CIRCUIT AND DRIVING METHOD THEREFOR, AND DISPLAY PANEL AND DISPLAY APPARATUS”, the entire contents of both of which are incorporated herein by reference.

### TECHNICAL FIELD

The present disclosure relates to the field of display technologies, and more particularly, to a pixel circuit and a method for driving the same, a display panel, and a display apparatus.

### BACKGROUND OF THE INVENTION

A micro light-emitting diode (micro-LED) is a light-emitting component with a size on the micrometer scale, have advantages such as high luminance, compact dimensions, and low power consumption, and is typically applied in some micro-display scenarios, for example, augmented reality (AR) scenarios.

In the related art, a pixel circuit for driving a micro-LED to emit light generally includes an analog circuit consisting of a data writing circuit and a driving circuit. The data writing circuit is coupled to a gate signal terminal, a data signal terminal and the driving circuit, respectively, and is configured to, based on a gate driving signal provided by the gate signal terminal, control a data signal terminal to transmit a data signal to the driving circuit. The driving circuit is further coupled to a driving power supply terminal and the micro-LED, respectively, and is configured to, based on the data signal and a driving power supply signal provided by the driving power supply terminal, transmit a light emission driving signal to the micro-LED, so as to drive the micro-LED to emit light.

However, limited by the smaller dimensions of the micro-LED, the driving stability of a current analog circuit for driving the micro-LED to emit light is poorer, which in turn results in an inferior display effect.

### SUMMARY OF THE INVENTION

A pixel circuit and a driving method thereof, a display panel, and a display apparatus are provided. The technical solutions are as follows.

In one aspect, a pixel circuit is provided. The pixel circuit includes:
a first driving circuit, coupled to a first gate signal terminal, a first data signal terminal, a first power supply terminal and a first node, respectively, and configured to, based on a first gate driving signal provided by the first gate signal terminal, a first data signal provided by the first data signal terminal and a first power supply signal provided by the first power supply terminal, transmit a light emission driving signal to the first node;
a second driving circuit, coupled to a second gate signal terminal, a second data signal terminal, a third data signal terminal, a driving terminal and a second node, respectively, and configured to, based on a second gate driving signal provided by the second gate signal terminal, a second data signal provided by the second data signal terminal, a third data signal provided by the third data signal terminal and a driving signal provided by the driving terminal, transmit a light emission control signal having a first potential or a second potential to the second node, wherein the first potential is a high potential relative to the second potential; and
a light emission control circuit, coupled to the first node, the second node and a light-emitting component, respectively, and configured to control switching on and switching off between the first node and the light-emitting component based on the light emission control signal received by the second node.

Optionally, the second driving circuit includes:
a switching sub-circuit, coupled to the second gate signal terminal, the second data signal terminal, the third data signal terminal and a third node, respectively, and configured to, based on the second gate driving signal, control switching on and switching off between the second data signal terminal and the third node, and control switching on and switching off between the third data signal terminal and the third node; and
an outputting sub-circuit, coupled to the third node, the driving terminal and the second node, respectively, and configured to transmit the light emission control signal to the second node based on a potential of the third node and the driving signal.

Optionally, the driving terminal includes a first reset terminal; the second gate signal terminal includes a first sub-gate signal terminal and a second sub-gate signal terminal;
the switching sub-circuit includes:
a first switching unit, coupled to the first sub-gate signal terminal, the second data signal terminal and the third node, respectively, and configured to control switching on and switching off between the second data signal terminal and the third node based on a first sub-gate driving signal provided by the first sub-gate signal terminal;
a second switching unit, coupled to the second sub-gate signal terminal, the third data signal terminal and the third node, respectively, and configured to control switching on and switching off between the third data signal terminal and the third node based on a second sub-gate driving signal provided by the second sub-gate signal terminal; and
the outputting sub-circuit includes:
an adjusting unit, coupled to the third node and a fourth node, respectively, and configured to adjust a potential of the fourth node based on the potential of the third node;
an inverting unit, coupled to the fourth node and the second node, respectively, and configured to invert the potential of the fourth node and transmit the inverted potential as the light emission control signal to the second node; and
a third switching unit, coupled to the first reset terminal, the fourth node and the second node, respectively, and configured to control switching on and switching off between the fourth node and the second node based on a first reset signal provided by the first reset terminal.

Optionally, the first switching unit includes a first transistor; the second switching unit includes a second transistor; the adjusting unit includes a first capacitor; the inverting unit includes an inverter; the third switching unit includes a third transistor;
a gate electrode of the first transistor is coupled to the first sub-gate signal terminal, a first electrode of the first transistor is coupled to the second data signal terminal, and a second electrode of the first transistor is coupled to the third node;
a gate electrode of the second transistor is coupled to the second sub-gate signal terminal, a first electrode of the second transistor is coupled to the third data signal terminal, and a second electrode of the second transistor is coupled to the third node;
one terminal of the first capacitor is coupled to the third node, and the other terminal of the first capacitor is coupled to the fourth node;
an input terminal of the inverter is coupled to the fourth node, and an output terminal of the inverter is coupled to the second node; and
a gate electrode of the third transistor is coupled to the first reset terminal, a first electrode of the third transistor is coupled to the fourth node, and a second electrode of the third transistor is coupled to the second node.

Optionally, the driving terminal includes the first power supply terminal and a second power supply terminal; the third node includes a first sub-node and a second sub-node;
the switching sub-circuit includes:
a first switching unit, coupled to the second gate signal terminal, the second data signal terminal and the first sub-node, respectively, and configured to control switching on and switching off between the second data signal terminal and the first sub-node based on the second gate driving signal;
a second switching unit, coupled to the second gate signal terminal, the third data signal terminal and the second sub-node, respectively, and configured to control switching on and switching off between the third data signal terminal and the second sub-node based on the second gate driving signal; and
the outputting sub-circuit includes:
two output units, wherein one output unit is coupled to the first sub-node, the first power supply terminal, the second power supply terminal and the second node, respectively, and the other output unit is coupled to the second sub-node, the first power supply terminal, the second power supply terminal and the second node, respectively, and the two output units are configured to, based on a potential of the first sub-node, a potential of the second sub-node, the first power supply signal, and a second power signal provided by the second power supply terminal, transmit the light emission control signal to the second node.

Optionally, the first switching unit includes a first transistor; the second switching unit includes a second transistor, in the two output units, one output unit includes a third transistor and a fourth transistor that have different types; the other output unit includes a fifth transistor and a sixth transistor that have different types;
a gate electrode of the first transistor is coupled to the second gate signal terminal, a first electrode of the first transistor is coupled to the second data signal terminal, and a second electrode of the first transistor is coupled to the first sub-node;
a gate electrode of the second transistor is coupled to the second gate signal terminal, a first electrode of the second transistor is coupled to the third data signal terminal, and a second electrode of the second transistor is coupled to the second sub-node;
a gate electrode of the third transistor and a gate electrode of the fourth transistor are both coupled to the first sub-node and the second node, a first electrode of the third transistor is coupled to the first power supply terminal, a first electrode of the fourth transistor is coupled to the second power supply terminal, and a second electrode of the third transistor and a second electrode of the fourth transistor are both coupled to the second sub-node; and
a gate electrode of the fifth transistor and a gate electrode of the sixth transistor are both coupled to the second sub-node and the second node, a first electrode of the fifth transistor is coupled to the first power supply terminal, a first electrode of the sixth transistor is coupled to the second power supply terminal, and a second electrode of the fifth transistor and a second electrode of the sixth transistor are both coupled to the first sub-node.

Optionally, the first driving circuit is further coupled to a second reset terminal and a second power supply terminal, respectively, and is configured to control switching on and switching off between the second power supply terminal and the first node based on a second reset signal provided by the second reset terminal;
the first driving circuit includes:
a data writing sub-circuit, coupled to the first gate signal terminal, the first data signal terminal and a fifth node, respectively, and configured to control switching on and switching off between the first data signal terminal and the fifth node based on the first gate driving signal;
a driving sub-circuit, wherein the driving sub-circuit has an input terminal coupled to the first power supply terminal, a driving terminal coupled to the fifth node, and an output terminal coupled to the first node, and the driving sub-circuit is configured to transmit the light emission driving signal to the first node based on the first power supply signal and a potential of the fifth node; and
a reset sub-circuit, coupled to the second reset terminal, the second power supply terminal and the first node, respectively, and configured to control switching on and switching off between the second power supply terminal and the first node based on the second reset signal.

Optionally, the data writing sub-circuit includes a seventh transistor; the driving sub-circuit includes an eighth transistor; the reset sub-circuit includes a ninth transistor;
a gate electrode of the seventh transistor is coupled to the first gate signal terminal, a first electrode of the seventh transistor is coupled to the first data signal terminal, and a second electrode of the seventh transistor is coupled to the fifth node;
a gate electrode of the eighth transistor is coupled to the fifth node, a first electrode of the eighth transistor is coupled to the first power supply terminal, and a second electrode of the eighth transistor is coupled to the first node; and
a gate electrode of the ninth transistor is coupled to the second reset terminal, a first electrode of the ninth transistor is coupled to the second power supply terminal, and a second electrode of the ninth transistor is coupled to the first node.

Optionally, the first driving circuit further includes:
a first adjusting sub-circuit, coupled to the fifth node and a target terminal, respectively, and configured to adjust the potential of the fifth node based on a potential of the target terminal;
the target terminal includes a reference power supply terminal, the first node, or an input terminal of the driving sub-circuit; and when the target terminal is the input terminal of the driving sub-circuit, the first driving circuit further includes:
a second adjusting sub-circuit, coupled to the first power supply terminal and the input terminal of the driving sub-circuit, respectively, and configured to adjust the potential of the input terminal of the driving sub-circuit based on the first power supply signal; and
a light emission control sub-circuit, coupled to a third gate signal terminal, the first power supply terminal and the input terminal of the driving sub-circuit, respectively, and configured to control switching on and switching off between the first power supply terminal and the input terminal of the driving sub-circuit based on a third gate driving signal provided by the third gate signal terminal.

Optionally, the first adjusting sub-circuit includes a second capacitor, the second adjusting sub-circuit includes a third capacitor; the light emission control sub-circuit includes a tenth transistor;
one terminal of the second capacitor is coupled to the target terminal, and the other terminal of the second capacitor is coupled to the fifth node;
one terminal of the third capacitor is coupled to the first power supply terminal, and the other terminal of the third capacitor is coupled to the input terminal of the driving sub-circuit; and
a gate electrode of the tenth transistor is coupled to the third gate signal terminal, a first electrode of the tenth transistor is coupled to the first power supply terminal, and a second electrode of the tenth transistor is coupled to the input terminal of the driving sub-circuit.

Optionally, the target terminal is the reference power supply terminal, and the transistor included in the data writing sub-circuit is a transmission gate switching transistor.

Optionally, the light emission control circuit includes an eleventh transistor,
a gate electrode of the eleventh transistor is coupled to the second node, a first electrode of the eleventh transistor is coupled to the first node, and a second electrode of the eleventh transistor is coupled to the light-emitting component.

In another aspect, a method for driving a pixel circuit is provided. The method is applicable to the pixel circuit according to the above one aspect, and includes:
in a first stage, transmitting, by a first driving circuit, a light emission driving signal to a first node, based on a first gate driving signal provided by a first gate signal terminal, a first data signal provided by a first data signal terminal and a first power supply signal provided by a first power supply terminal; and
in a second stage: transmitting, by a second driving circuit, a light emission control signal having a target potential to a second node, based on a second gate driving signal provided by a second gate signal terminal, a second data signal provided by a second data signal terminal, a third data signal provided by a third data signal terminal and a driving signal provided by a driving terminal, wherein the target potential includes a first potential or a second potential, and the first potential is a high potential relative to the second potential; and controlling, by a light emission control circuit, a connection between the first node and a light-emitting component to be switched on based on the light emission control signal of the target potential received by the second node, to drive the light-emitting component to emit light, wherein a switching-on duration between the first node and the light-emitting component is positively correlated with an uninterrupted duration of the target potential.

In yet another aspect, a display panel is provided, and includes a substrate, and a plurality of pixels disposed on one side of the substrate,
wherein each pixel includes a light-emitting component, and the pixel circuit according to any one of the above aspects; and the pixel circuit is coupled to the light-emitting component and is configured to drive the light-emitting component to emit light.

In still another aspect, a display apparatus is provided, and includes a power supply assembly, and the display panel according to the above yet another aspect,
wherein the power supply assembly is coupled to the display panel and is configured to supply power to the display panel.

### BRIEF DESCRIPTION OF DRAWINGS

For clearer descriptions of the technical solutions in the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a schematic structural diagram of a pixel circuit according to an embodiment of the present disclosure;

FIG. 2 is a schematic structural diagram of another pixel circuit according to an embodiment of the present disclosure;

FIG. 3 is a schematic structural diagram of yet another pixel circuit according to an embodiment of the present disclosure;

FIG. 4 is a schematic structural diagram of still another pixel circuit according to an embodiment of the present disclosure;

FIG. 5 is a schematic structural diagram of still another pixel circuit according to an embodiment of the present disclosure;

FIG. 6 is a schematic structural diagram of still another pixel circuit according to an embodiment of the present disclosure;

FIG. 7 is a schematic structural diagram of still another pixel circuit according to an embodiment of the present disclosure;

FIG. 8 is a schematic structural diagram of still another pixel circuit according to an embodiment of the present disclosure;

FIG. 9 is a schematic structural diagram of still another pixel circuit shown based on FIG. 5;

FIG. 10 is a schematic structural diagram of still another pixel circuit shown based on FIG. 6;

FIG. 11 is a schematic structural diagram of still another pixel circuit shown based on FIG. 7;

FIG. 12 is a schematic structural diagram of still another pixel circuit shown based on FIG. 8;

FIG. 13 is a flowchart of a method for driving a pixel circuit according to an embodiment of the present disclosure;

FIG. 14 is a working timing diagram of a pixel circuit shown based on the structure in FIG. 11;

FIG. 15 is a working timing diagram of a second driving circuit shown based on FIG. 14;

FIG. 16 is a schematic structural diagram of a display panel according to an embodiment of the present disclosure; and

FIG. 17 is a schematic structural diagram of a display apparatus according to an embodiment of the present disclosure.

### DETAILED DESCRIPTION

To make the objectives, technical solutions and advantages of the present disclosure clearer, the embodiments of the present disclosure will be further described in detail below with reference to the accompanying drawings.

It should be noted that transistors used in all embodiments of the present disclosure may be thin-film transistors or field-effect transistors or other devices with the same characteristics. According to their roles in circuits, the transistors used in the embodiments of the present disclosure are mainly switching transistors. Since a source electrode and a drain electrode of the switching transistor used herein are symmetrical, its source electrode and drain electrode are interchangeable. In embodiments of the present disclosure, the source electrode is referred to as a first electrode, and the drain electrode is referred to as a second electrode. According to a form in the accompanying drawings, a middle terminal of the transistor is defined as a control electrode, which may also be called a gate electrode; a signal input terminal is the source electrode; and the signal output terminal is the drain electrode. Furthermore, the switching transistors adopted in the embodiments of the present disclosure may include either P-type switching transistors or N-type switching transistors, wherein the P-type switching transistor is switched on when the gate electrode is at a low level, and is cut off when the gate electrode is at a high level; and the N-type switching transistor is switched on when the gate electrode is at the high level, and is cut off when the gate is at the low level. Furthermore, each of a plurality of signals in the various embodiments of the present disclosure correspondingly has a first potential and a second potential. The first potential and the second potential only represent that the potential of the signal has two discrete states, and do not represent that the first potential or the second potential has a specific numerical value throughout the Description.

In recent years, AR display products have developed rapidly. They may use optical waveguide technology to achieve light emission display, enabling the AR display products to be thinner and lighter. However, the light loss in the optical waveguide technology is generally large, requiring higher device luminance. To address this, a silicon-based organic light-emitting diode (OLED), which is self-luminous and can still achieve a thin and light form, is also currently considered for light emission display. However, since the light emission luminance of the silicon-based OLED is limited by its lifespan issue, the AR display product using the silicon-based OLED can only operate at lower luminance generally less than 1500 nits, which cannot meet the high luminance requirement. To this end, the use of an LED for light emission display is further considered. As an inorganic light-emitting device, the LED can be used at luminance levels of millions of nit (or even higher), meeting the requirements for use in more extreme environments. Although a micro-LED applied to an AR display product is still in the early stage of commercialization, it is expected to become the main technology for micro-display in the future, An AR display product usually requires a pixel density of 5000 PPI or higher, wherein PPI refers to the number of pixels per inch of the display panel, and indicates resolution, which means that the spacing between adjacent pixels is at least less than 5 micrometers. Since the display size of a micro-display like the AR display product is generally less than 1 inch, the silicon-based micro-LED becomes a better candidate for a backplate with a smaller pixel size and an integrated peripheral circuit. In addition, pixel circuits for driving micro-LEDs commonly adopt the complementary metal-oxide-semiconductor (CMOS) technology.

In AR display products, there is often a demand for more stable display, such as in outdoor sports devices or wearable watches, which have higher requirements for anti-interference from the external environment. In addition, since they require lower display gray scales, a more stable and reliable driving method is required. The embodiments of the present disclosure provide a pixel circuit that may combine an analog circuit and a digital circuit to reliably drive a light-emitting component such as a micro-LED to emit light, ensuring better display stability.

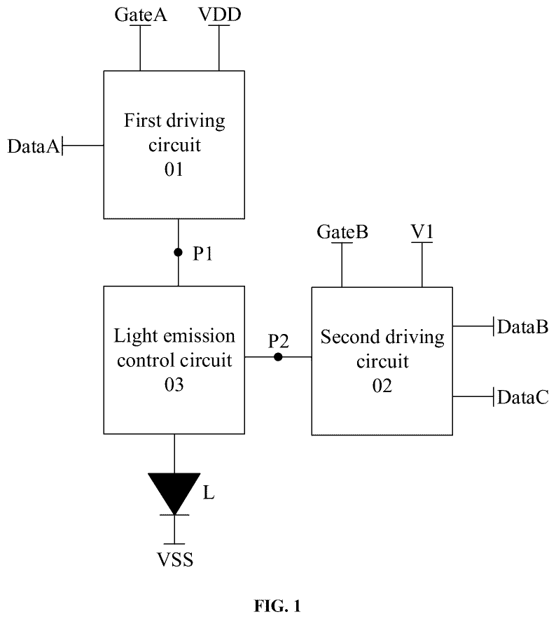

FIG. 1 is a schematic structural diagram of a pixel circuit according to an embodiment of the present disclosure. As shown in FIG. 1, the pixel circuit includes: a first driving circuit 01, a second driving circuit 02, and a light emission control circuit 03.

The first driving circuit 01 is coupled to a first gate signal terminal GateA, a first data signal terminal DataA, a first power supply terminal VDD and a first node P1, respectively. The first driving circuit 01 is configured to, based on a first gate driving signal provided by the first gate signal terminal GateA, a first data signal provided by the first data signal terminal DataA and a first power supply signal provided by the first power supply terminal VDD, transmit a light emission driving signal to a first node P1. For a micro-LED, the transmitted light emission driving signal herein may be a driving current.

The second driving circuit 02 is coupled to a second gate signal terminal GateB, a second data signal terminal DataB, a third data signal terminal DataC, a driving terminal V1, and a second node P2, respectively. The second driving circuit 02 is configured to, based on a second gate driving signal provided by the second gate signal terminal GateB, a second data signal provided by the second data signal terminal DataB, a third data signal provided by the third data signal terminal DataC, and a driving signal provided by the driving terminal V1, transmit a light emission control signal having a first potential or a second potential to the second node P2.

Optionally, the first potential may be a high potential relative to the second potential. That is, the first potential may be a high potential, and the second potential may be a low potential. The light emission control signal described in the embodiments of the present disclosure may have characteristics similar to a digital signal, namely, is capable of switching between a high potential and a low potential in a form of instantaneous transition, and is either at the high potential or at the low potential during a time period.

It should be noted that, in the first potential and the second potential, one potential may also be considered an active potential (e.g., high potential), and the other potential may also be considered an inactive potential (e.g., low potential). Exemplarily, in the embodiments of the present disclosure, the active level may refer to the first potential, and the inactive potential may refer to the second potential. That is, the active potential may be a high potential relative to the inactive potential. Of course, in some other embodiments, the active potential may refer to the second potential, and the inactive potential may refer to the first potential, i.e., the active potential is a low potential relative to the inactive potential.

The light emission control circuit 03 is coupled to the first node P1, the second node P2 and a light-emitting component L, respectively. The light emission control circuit 03 is configured to control the switching on and switching off between the first node P1 and the light-emitting component L based on the light emission control signal received by the second node P2.

Optionally, the light emission control circuit 03 may be coupled to a first electrode of the light-emitting component L, and a second electrode of the light-emitting component L may also be coupled to a second power supply terminal VSS. The light-emitting component L may emit light under the action of the voltage difference between the light emission driving signal received by the first electrode and the second power supply signal provided by the second power supply terminal VSS. In the first electrode and the second electrode of the light-emitting component L, one may be the anode and the other may be the cathode. FIG. 1 shows the first electrode as the anode and the second electrode as the cathode. In addition, the light-emitting component L may be a micro-LED.

For example, the light emission control circuit 03 may control the connection between the first node P1 and the light-emitting component L to be switched on when the potential of the light emission control signal received by the second node P2 is the active potential. In this case, the light emission driving signal received by the first node P1 may be further transmitted to the light-emitting component L, thereby driving the light-emitting component L to emit light. In addition, the light emission control circuit 03 may control the first node P1 to be decoupled from the light-emitting component L when the potential of the light emission control signal received by the second node P2 is the inactive potential.

Thus, it can be seen that a light emission gray scale of the light-emitting component L is related to the light emission driving signal, and a light emission duration of the light-emitting component L is positively correlated with an uninterrupted duration for which the light emission control signal is at the active potential. That is, the longer the duration for which the light emission control signal is at the active potential, the longer the light emission duration of the light-emitting component L, and thus the greater the light emission luminance of the light-emitting component L under the same light emission driving signal; and conversely, the shorter the duration for which the light emission control signal is at the active potential, the shorter the light emission duration of the light-emitting component L, and thus the lower the light emission luminance of the light-emitting component L under the same light emission driving signal. Assuming, as recorded in the above embodiments, that the first potential (i.e., high potential) is the active potential and the second potential (i.e., low potential) is the inactive potential, that is, the active potential is a high potential relative to the inactive potential, it can be seen that the light emission duration of the light-emitting component L may be positively correlated with an uninterrupted duration for which the light emission control signal is at the high potential. Thus, it can be seen that the light emission control signal may provide a preset strobe time for the light-emitting component, namely, control the light emission duration of the light-emitting component.

Since the potential of the light emission control signal generated by the second driving circuit 02 has a transition characteristic of a digital signal, the second driving circuit 02 may be understood as the digital section in the pixel circuit. In other words, the digital circuit here does not mean that the second driving circuit 02 is a type of digital circuit capable of converting an analog signal to a digital signal, but rather intends to express that the signal provided by the second driving circuit 02 has the instantaneous transition characteristic of the digital signal. Since the first driving circuit 01 generates a light emission driving signal based on the analog signal such as a gate driving signal and a data signal, and the light emission control circuit 03 is configured to transmit the light emission driving signal to the light-emitting component L, it can be considered that, excluding the second driving circuit 02 (i.e., the digital section), a section including the first driving circuit 01 and a light emission control circuit 03 may be the analog section in the pixel circuit, belonging to an analog circuit. That is, the pixel circuit recorded in the embodiments of the present disclosure includes an analog section that generates the light emission driving signal and a digital section that generates the light emission control signal, which together control the light emission of the light-emitting component L. The light emission driving signal is capable of determining the light emission gray scale of the light-emitting component L; and the light emission control signal is capable of determining the light emission duration of the light-emitting component L, and together with the light emission driving signal, determining the light emission luminance of the light-emitting component L. In this way, stable and reliable driving of the light-emitting component L to emit light can be ensured, thereby ensuring better display stability.

In summary, the embodiments of the present disclosure provide a pixel circuit. The pixel circuit includes: a first driving circuit, a second driving circuit, and a light emission control circuit. The first driving circuit is capable of transmitting a light emission driving signal to a first node based on signals provided by all signal terminals coupled to the first driving circuit; and the second driving circuit is capable of transmitting a light emission control signal having a first potential or a second potential to a second node based on signals provided by all signal terminals coupled to the second driving circuit. A light emission control circuit is capable of controlling switching on and switching off between the first node and a light-emitting component based on the light emission control signal. When connection between the first node and the light-emitting component is switched on, the light emission driving signal received by the first node may be further transmitted to the light-emitting component to drive the light-emitting component to emit light. The first potential is a high potential relative to the second potential, that is, the first potential is a high potential and the second potential is a low potential. Thus, it can be seen that the light emission control signal not only has characteristics similar to a digital signal but also can provide a preset strobe time for the light-emitting component, namely, control a light emission duration of the light-emitting component. Therefore, driving of the light-emitting component to emit light stably can be ensured, such that display stability of the display panel can be better.

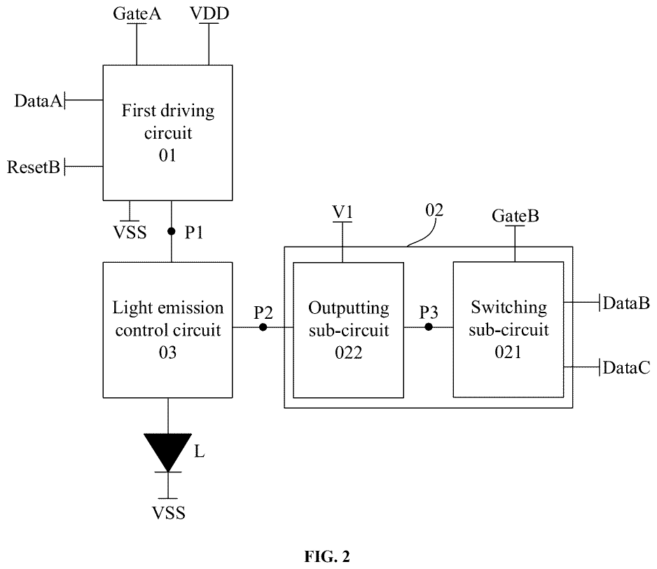

FIG. 2 is a schematic structural diagram of another pixel circuit according to an embodiment of the present disclosure. As shown in FIG. 2, the second driving circuit 02 may include: a switching sub-circuit 021 and an outputting sub-circuit 022.

The switching sub-circuit 021 may be coupled to a second gate signal terminal GateB, a second data signal terminal DataB, a third data signal terminal DataC, and a third node P3, respectively. The switching sub-circuit 021 may be configured to, based on the second gate driving signal, control switching on and switching off between the second data signal terminal DataB and a third node P3, and control switching on and switching off between the third data signal terminal DataC and the third node P3.

For example, the switching sub-circuit 021 may control both the connection between the second data signal terminal DataB and the third node P3 and the connection between the third data signal terminal DataC and the third node P3 to be switched on when the potential of the second gate electrode driving is the first potential. In this case, both the second data signal provided by the second data signal terminal DataB and the third data signal provided by the third data signal terminal DataC may be transmitted to the third node P3. In addition, the switching sub-circuit 021 may control both the second data signal terminal DataB and the third data signal terminal DataC to be decoupled from the third node P3 when the potential of the second gate driving signal is the second potential.

The outputting sub-circuit 022 may be coupled to the third node P3, a driving terminal V1, and the second node P2, respectively. The outputting sub-circuit 022 may be configured to, based on the potential of the third node P3 and the driving signal provided by the driving terminal V1, transmit the light emission control signal to the second node P2.

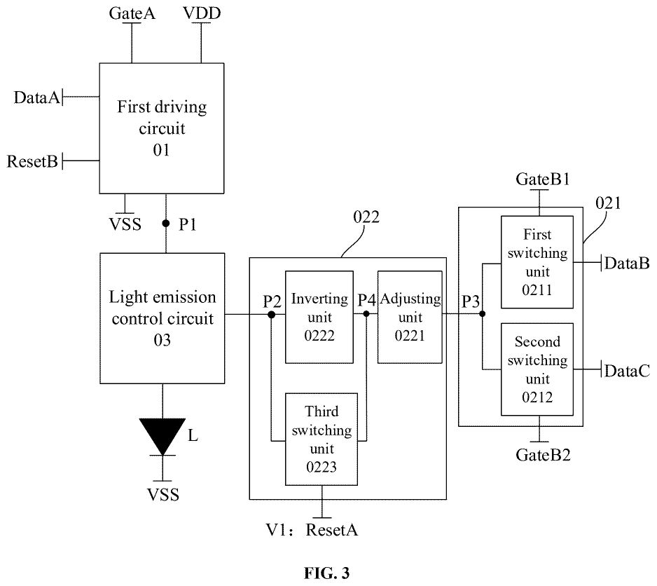

As an optional implementation, in another pixel circuit shown in FIG. 3, the driving terminal V1 may include: a first reset terminal ResetA. The second gate signal terminal GateB may include: a first sub-gate signal terminal GateB1 and a second sub-gate signal terminal GateB2. On this basis, the switching sub-circuit 021 may include: a first switching unit 0211 and a second switching unit 0212. The outputting sub-circuit 022 may include: an adjusting unit 0221, an inverting unit 0222, and a third switching unit 0223.

The first switching unit 0211 may be coupled to the first sub-gate signal terminal GateB1, the second data signal terminal DataB, and the third node P3, respectively. The first switching unit 0211 may be configured to control switching on and switching off between the second data signal terminal DataB and the third node P3 based on a first sub-gate driving signal provided by the first sub-gate signal terminal GateB1.

For example, the first switching unit 0211 may control the connection between the second data signal terminal DataB and the third node P3 to be switched on when the potential of the first sub-gate driving signal provided by the first sub-gate signal terminal GateB1 is the first potential. In this case, the second data signal provided by the second data signal terminal DataB can be transmitted to the third node P3. In addition, the first switching unit 0211 may control the second data signal terminal DataB to be decoupled from the third node P3 when the potential of the first sub-gate driving signal provided by the first sub-gate signal terminal GateB1 is the second potential.

The second switching unit 0212 may be coupled to the second sub-gate signal terminal GateB2, the third data signal terminal DataC, and the third node P3, respectively. The second switching unit 0212 may be configured to control switching on and switching off between the third data signal terminal DataC and the third node P3 based on a second sub-gate driving signal provided by the second sub-gate signal terminal GateB2.

For example, the second switching unit 0212 may control the connection between the third data signal terminal DataC and the third node P3 to be switched on when the potential of the second sub-gate driving signal provided by the second sub-gate signal terminal GateB2 is the first potential. In this case, the third data signal provided by the third data signal terminal DataC may be transmitted to the third node P3. In addition, the second switching unit 0212 may control the third data signal terminal DataC to be decoupled from the third node P3 when the potential of the second sub-gate driving signal provided by the second sub-gate signal terminal GateB2 is the second potential.

The adjusting unit 0221 may be coupled to the third node P3 and a fourth node P4, respectively. The adjusting unit 0221 may be configured to adjust a potential of the fourth node P4 based on a potential of the third node P3.

For example, the adjusting unit 0221 may adjust the potential of the fourth node P4 based on the potential of the third node P3 through a coupling action.

The inverting unit 0222 may be coupled to the fourth node P4 and the second node P2, respectively. The inverting unit 0222 may be configured to invert the potential of the fourth node P4 and transmit the inverted potential as the light emission control signal to the second node P2.

For example, assuming that the potential of the fourth node P4 is at a low potential, the inverting unit 0222 may invert it to a high potential and transmit the inverted potential as the light emission control signal to the second node P2. Conversely, assuming that the potential of the fourth node P4 is at a high potential, the inverting unit 0222 may invert it to a low potential and transmit the inverted potential as the light emission control signal to the second node P2.

The third switching unit 0223 may be coupled to the first reset terminal ResetA, the fourth node P4, and the second node P2, respectively. The third switching unit 0223 may be configured to control switching on and switching off between the fourth node P4 and the second node P2 based on a first reset signal provided by the first reset terminal ResetA.

For example, the third switching unit 0223 may control the connection between the fourth node P4 and the second node P2 to be switched on when the potential of the first reset signal provided by the first reset terminal ResetA is the first potential. In addition, the third switching unit 0223 may control the fourth node P4 to be decoupled from the second node P2 when the potential of the first reset signal provided by the first reset terminal ResetA is the second potential.

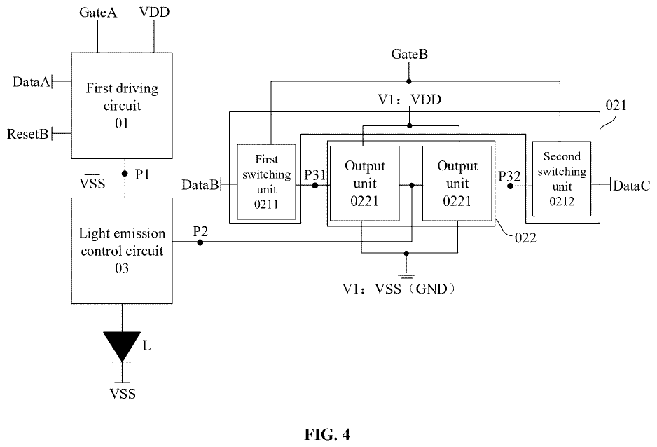

As anther optional implementation, in yet another pixel circuit shown in FIG. 4, the driving terminal V1 may include: the first power supply terminal VDD and a second power supply terminal VSS. Optionally, the second power supply terminal VSS here may be a ground terminal GND, or may be shared with the second power supply terminal VSS coupled to the cathode of the light-emitting component L. The third node P3 may include: a first sub-node P31 and a second sub-node P32. On this basis, the switching sub-circuit 021 may include: a first switching unit 0211 and a second switching unit 0212. The outputting sub-circuit 022 may include: two output units 0221.

The first switching unit 0211 may be coupled to the second gate signal terminal GateB, the second data signal terminal DataB, and the first sub-node P31, respectively. The first switching unit 0211 may be configured to control switching on and switching off between the second data signal terminal DataB and the first sub-node P31 based on the second gate driving signal.

For example, the first switching unit 0211 may control the connection between the second data signal terminal DataB and the first sub-node P31 to be switched on when the potential of the second gate driving signal is the first potential. In this case, the second data signal provided by the second data signal terminal DataB may be transmitted to the first sub-node P31. In addition, the first switching unit 0211 may control the second data signal terminal DataB to be decoupled from the first sub-node P31 when the potential of the second gate driving signal is the second potential.

The second switching unit 0212 may be coupled to the second gate signal terminal GateB, the third data signal terminal DataC, and the second sub-node P32, respectively. The second switching unit 0212 may be configured to control switching on and switching off between the third data signal terminal DataC and the second sub-node P32 based on the second gate driving signal.

For example, the second switching unit 0212 may control the connection between the third data signal terminal DataC and the second sub-node P32 to be switched on when the potential of the second gate driving signal is the first potential. In this case, the third data signal provided by the third data signal terminal DataC may be transmitted to the second sub-node P32. In addition, the second switching unit 0212 may control the third data signal terminal DataC to be decoupled from the second sub-node P32 when the potential of the second gate driving signal is the second potential.

In the two output units 0221, one output unit 0221 may be coupled to the first sub-node P31, the first power supply terminal VDD, the second power supply terminal VSS, and the second node P2, respectively; and the other output unit 0221 may be coupled to the second sub-node P32, the first power supply terminal VDD, the second power supply terminal VSS, and the second node P2, respectively. The two output units 0221 may be configured to, based on the potential of the first sub-node P31, the potential of the second sub-node P32, the first power supply signal, and a second power supply signal provided by the second power supply terminal VSS, transmit the light emission control signal to the second node P2.

Optionally, referring to FIGS. 2 to 4, it can also be seen that the first driving circuit 01 recorded in the embodiments of the present disclosure may be further coupled to a second reset terminal ResetB and the second power supply terminal VSS, and may be configured to control switching on and switching off between the second power supply terminal VSS and the first node P1 based on a second reset signal provided by the second reset terminal ResetB. Optionally, the second power supply terminal VSS here may also be a ground terminal GND.

For example, the first driving circuit 01 may control the connection between the second power supply terminal VSS and the first node P1 to be switched on when the potential of the second reset signal provided by the second reset terminal ResetB is the first potential. In this case, the second power supply signal provided by the second power supply terminal VSS may be transmitted to the first node P1. In addition, the first driving circuit 01 may control the second power supply terminal VSS to be decoupled from the first node P1 when the potential of the second reset signal provided by the second reset terminal ResetB is the second potential.

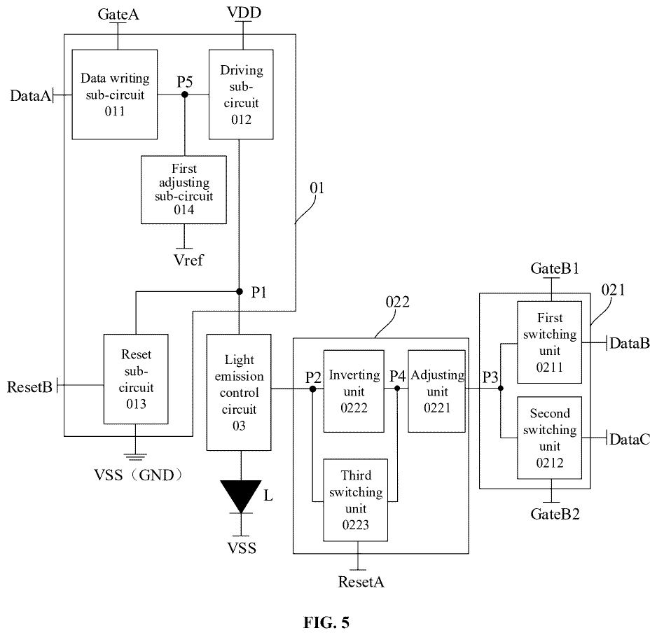

Based on the structure shown in FIG. 3, continuing to refer to still another pixel circuit shown in FIG. 5, it can be seen that the first driving circuit 01 may include: a data writing sub-circuit 011, a driving sub-circuit 012, and a reset sub-circuit 013.

The data writing sub-circuit 011 may be coupled to the first gate signal terminal GateA, the first data signal terminal DataA, and a fifth node P5, respectively. The data writing sub-circuit 011 may be configured to control switching on and switching off between the first data signal terminal DataA and the fifth node P5 based on the first gate driving signal.

For example, the data writing sub-circuit 011 may control the connection between the first data signal terminal DataA and the fifth node P5 to be switched on when the potential of the first gate driving signal is the first potential. In this case, the first data signal provided by the first data signal terminal DataA may be transmitted to the fifth node P5. In addition, the data writing sub-circuit 011 may control the first data signal terminal DataA to be decoupled from the fifth node P5 when the potential of the first gate driving signal is the second potential.

An input terminal of the driving sub-circuit 012 may be coupled to the first power supply terminal VDD, a driving terminal of the driving sub-circuit 012 may be coupled to the fifth node P5, and an output terminal of the driving sub-circuit 012 may be coupled to the first node P1. The driving sub-circuit 012 may be configured to, based on the first power supply signal and the potential of the fifth node P5, transmit the light emission driving signal to the first node P1.

The reset sub-circuit 013 may be coupled to the second reset terminal ResetB, the second power supply terminal VSS, and the first node Pl, respectively. The reset sub-circuit 013 may be configured to control switching on and switching off between the second power supply terminal VSS and the first node P1 based on the second reset signal.

For example, as recorded in the above embodiments, the reset sub-circuit 013 may control the connection between the second power supply terminal VSS and the first node P1 to be switched on when the potential of the second reset signal is the first potential. In addition, the reset sub-circuit 013 may control the second power supply terminal VSS to be decoupled from the first node P1 when the potential of the second reset signal is the second potential.

Optionally, continuing to refer to the pixel circuit shown in FIG. 5, it can be seen that the first driving circuit 01 recorded in the embodiments of the present disclosure may further include: a first adjusting sub-circuit 014.

The first adjusting sub-circuit 014 may be coupled to the fifth node P5 and a target terminal, respectively. The first adjusting sub-circuit 014 may be configured to adjust the potential of the fifth node P5 based on a potential of the target terminal.

Optionally, as an optional implementation, as shown in FIG. 5, the target terminal may include: a reference power supply terminal Vref. Correspondingly, the first adjusting sub-circuit 014 may adjust the potential of the fifth node P5 based on a reference power supply signal provided by the reference power supply terminal Vref.

Optionally, as another optional implementation, on the basis of the structure shown in FIG. 3, referring to still another pixel circuit shown in FIG. 6, the target terminal may include: the first node P1. Correspondingly, the first adjusting sub-circuit 014 may adjust the potential of the fifth node P5 based on the potential of the first node P1. For example, the potential of the first node P1 may be the potential of the second power supply signal transmitted from the second power supply terminal VSS to the first node Pl when the reset sub-circuit 013 controls the connection between the second power supply terminal VSS and the first node P1 to be switched on.

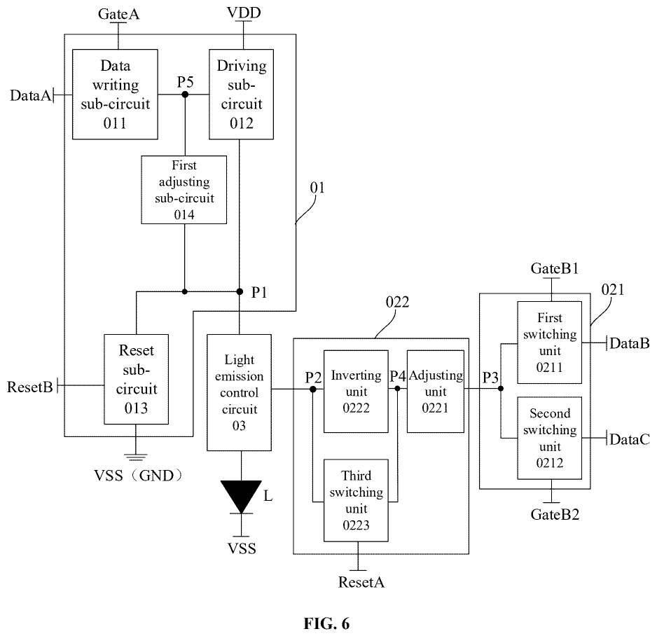

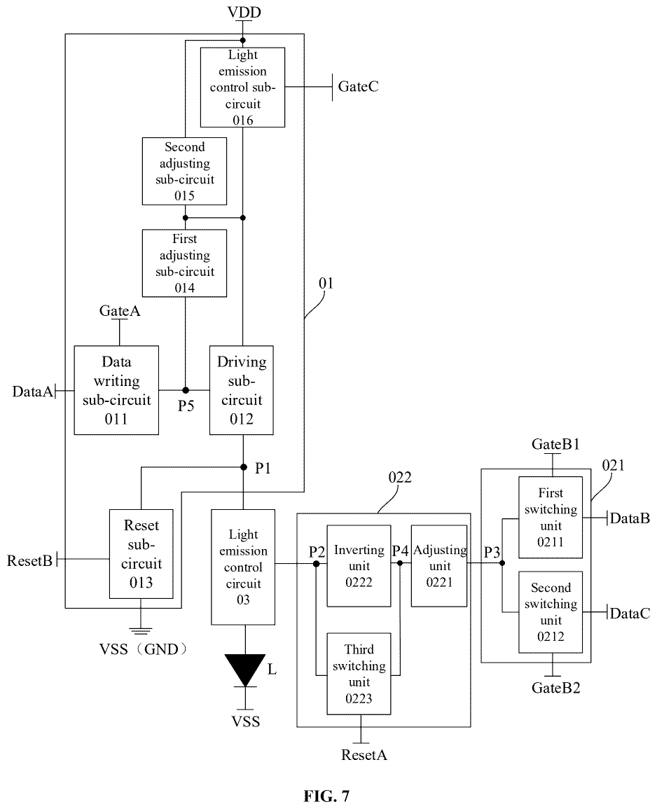

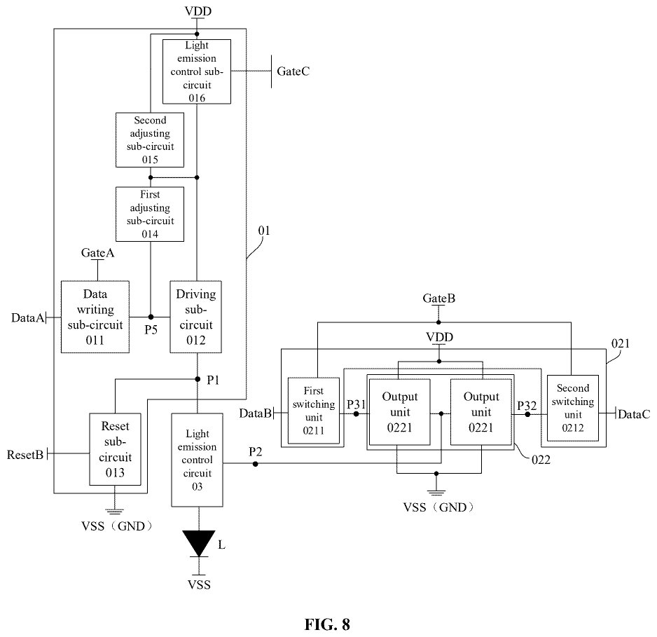

Optionally, as yet another optional implementation, on the basis of FIGS. 3 and 4, referring to still another pixel circuit shown in FIGS. 7 and 8, the target terminal may include: the input terminal of the driving sub-circuit 012 (i.e., one terminal coupled to the first power supply terminal VDD). Correspondingly, the first adjusting sub-circuit 014 may adjust the potential of the fifth node P5 (i.e., the driving terminal of the driving sub-circuit 012) based on the potential of the input terminal of the driving sub-circuit 012. In addition, on this basis, the first driving circuit 01 recorded in the embodiments of the present disclosure may further include: a second adjusting sub-circuit 015 and a light emission control sub-circuit 016.

The second adjusting sub-circuit 015 may be coupled to the first power supply terminal VDD and the input terminal of the driving sub-circuit 012, respectively. The second adjusting sub-circuit 015 may be configured to adjust the potential of the input terminal of the driving sub-circuit 012 based on the first power supply signal.

For example, the second adjusting sub-circuit 015 may adjust the potential of the input terminal of the driving sub-circuit 012 through a coupling action.

The light emission control sub-circuit 016 may be coupled to a third gate signal terminal GateC, the first power supply terminal VDD, and the input terminal of the driving sub-circuit 012, respectively. The light emission control sub-circuit 016 may be configured to control switching on and switching off between the first power supply terminal VDD and the input terminal of the driving sub-circuit 012 based on a third gate driving signal provided by the third gate signal terminal GateC.

For example, the light emission control sub-circuit 016 may control the connection between the first power supply terminal VDD and the input terminal of the driving sub-circuit 012 to be switched on when the potential of the third gate driving signal provided by the third gate signal terminal GateC is the first potential. In this case, the first power supply signal provided by the first power supply terminal VDD may be transmitted to the input terminal of the driving sub-circuit 012. In addition, the light emission control sub-circuit 016 may control the first power supply terminal VDD to be decoupled from the input terminal of the driving sub-circuit 012 when the potential of the third gate driving signal provided by the third gate signal terminal GateC is the second potential. In other words, the input terminal of the driving sub-circuit 012 is indirectly coupled to the first power supply terminal VDD.

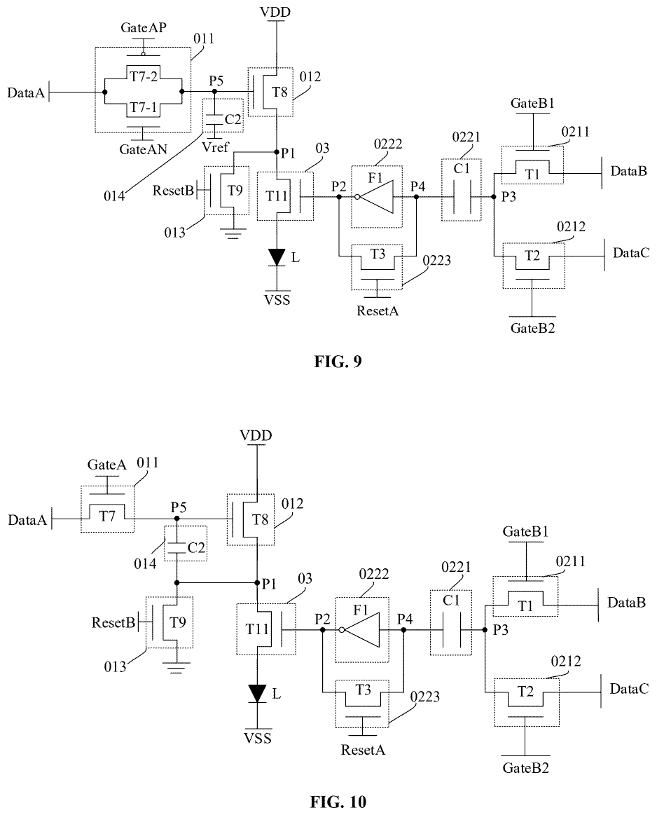

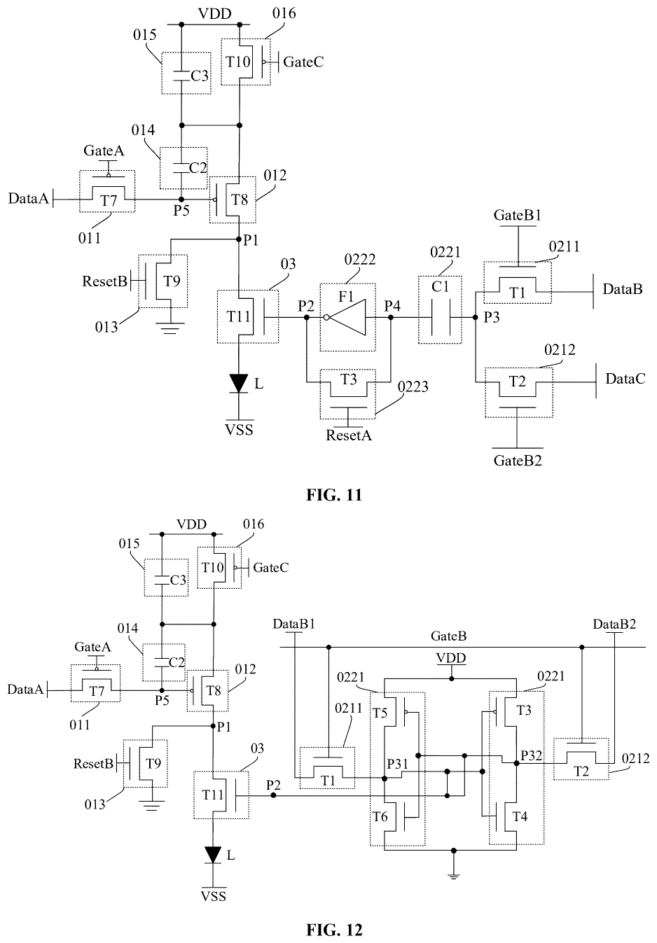

Optionally, on the basis of the structure shown in FIG. 5, FIG. 9 correspondingly shows a schematic structural diagram of still another pixel circuit. On the basis of the structure shown in FIG. 6, FIG. 10 correspondingly shows a schematic structural diagram of still another pixel circuit. On the basis of the structure shown in FIG. 7, FIG. 11 correspondingly shows a schematic structural diagram of still another pixel circuit. On the basis of the structure shown in FIG. 8, FIG. 12 correspondingly shows a schematic structural diagram of still another pixel circuit.

First, referring to FIGS. 9 to 11, it can be seen that for the second driving circuit 02 shown in FIGS. 5 to 7, the first switching unit 0211 may include: a first transistor T1. The second switching unit 0212 may include: a second transistor T2. The adjusting unit 0221 may include: a first capacitor C1. The inverting unit 0222 may include: an inverter F1. The third switching unit 0223 may include: a third transistor T3.

A gate electrode of the first transistor T1 may be coupled to the first sub-gate signal terminal GateB1, a first electrode of the first transistor T1 may be coupled to the second data signal terminal DataB, and a second electrode of the first transistor T1 may be coupled to the third node P3.

A gate electrode of the second transistor T2 may be coupled to the second sub-gate signal terminal GateB2, a first electrode of the second transistor T2 may be coupled to the third data signal terminal DataC, and a second electrode of the second transistor T2 may be coupled to the third node P3.

One terminal of the first capacitor C1 may be coupled to the third node P3, and the other terminal of the first capacitor C1 may be coupled to the fourth node P4.

An input terminal of the inverter F1 is coupled to the fourth node P4, and an output terminal of the inverter F1 is coupled to the second node P2.

A gate electrode of the third transistor T3 may be coupled to the first reset terminal ResetA, a first electrode of the third transistor T3 may be coupled to the fourth node P4, and a second electrode of the third transistor T3 may be coupled to the second node P2.

Second, referring to FIG. 12, it can be seen that for the second driving circuit 02 shown in FIG. 8, the first switching unit 0211 may include: a first transistor T1. The second switching unit 0212 may include: a second transistor T2. In the two output units 0221, one output unit 0221 may include: a third transistor T3 and a fourth transistor T4 that have different types. The other output unit 0221 may include: a fifth transistor T5 and a sixth transistor T6 that have different types.

A gate electrode of the first transistor T1 may be coupled to the second gate signal terminal GateB, a first electrode of the first transistor T1 may be coupled to the second data signal terminal DataB, and a second electrode of the first transistor T1 may be coupled to the first sub-node P31.

A gate electrode of the second transistor T2 may be coupled to the second gate signal terminal GateB, a first electrode of the second transistor T2 may be coupled to the third data signal terminal DataC, and a second electrode of the second transistor T2 may be coupled to the second sub-node P32.

A gate electrode of the third transistor T3 and a gate electrode of the fourth transistor T4 may be both coupled to the first sub-node P31 and the second node P2, a first electrode of the third transistor T3 may be coupled to the first power supply terminal VDD, a first electrode of the fourth transistor T4 may be coupled to the second power supply terminal VSS (e.g., grounded), and a second electrode of the third transistor T3 and a second electrode of the fourth transistor T4 may be both coupled to the second sub-node P32.

A gate electrode of the fifth transistor T5 and a gate electrode of the sixth transistor T6 may be both coupled to the second sub-node P32 and the second node P2, a first electrode of the fifth transistor T5 may be coupled to the first power supply terminal VDD, a first electrode of the sixth transistor T6 may be coupled to the second power supply terminal VSS (e.g., grounded), and a second electrode of the fifth transistor T5 and a second electrode of the sixth transistor T6 may be both coupled to the first sub-node P31.

It should be noted that for the structure shown in FIG. 8, the two output units 0221 including the third transistor T3, the fourth transistor T4, the fifth transistor T5, and the sixth transistor T6 as shown in FIG. 12 may refer to a latch formed by a CMOS circuit.

Third, referring to FIGS. 9 to 12, it can be seen that for the first driving circuit 01 shown in FIGS. 5 to 8, the data writing sub-circuit 011 may include: a seventh transistor T7. The driving sub-circuit 012 may include: an eighth transistor T8. The reset sub-circuit 013 may include: a ninth transistor T9. The first adjusting sub-circuit 014 may include: a second capacitor C2.

A gate electrode of the seventh transistor T7 may be coupled to the first gate signal terminal GateA, a first electrode of the seventh transistor T7 may be coupled to the first data signal terminal DataA, and a second electrode of the seventh transistor T7 may be coupled to the fifth node P5.

A gate electrode of the eighth transistor T8 may be coupled to the fifth node P5, a first electrode of the eighth transistor T8 may be coupled to the first power supply terminal VDD, and a second electrode of the eighth transistor T8 may be coupled to the first node P1.

A gate electrode of the ninth transistor T9 may be coupled to the second reset terminal ResetB, a first electrode of the ninth transistor T9 may be coupled to the second power supply terminal VSS (e.g., a ground terminal GND), and a second electrode of the ninth transistor T9 may be coupled to the first node P1.

One terminal of the second capacitor C2 may be coupled to the target terminal, and the other terminal of the second capacitor C2 may be coupled to the fifth node PS.

As an optional implementation, referring to FIG. 9, it can be seen that for the pixel circuit with the structure shown in FIG. 5, one terminal of the second capacitor C2 may be coupled to a target terminal “reference power supply terminal Vref”. On this basis, the transistor included in the data writing sub-circuit 011 may be a transmission gate switching transistor. That is, it may be a CMOS transistor including an N-type transistor T7-1 and a P-type transistor T7-2. Correspondingly, referring to FIG. 9, it can also be seen that the first gate signal terminal GateA may include: a first gate signal terminal GateAN coupled to the gate electrode of the N-type transistor T7-1, and a first gate signal terminal GateAP coupled to the gate electrode of the P-type transistor T7-2.

As another optional implementation, referring to FIG. 10, it can be seen that for the pixel circuit with the structure shown in FIG. 6, one terminal of the second capacitor C2 may be coupled to the target terminal “first node P1”.

As yet another optional implementation, referring to FIGS. 11 and 12, for the pixel circuits with the structures shown in FIGS. 7 and 8, it can be seen that one terminal of the second capacitor C2 may be coupled to a target terminal “input terminal of the driving sub-circuit 012 (i.e., the first electrode of the eighth transistor T8)”. In addition, on this basis, continuing to refer to FIGS. 11 and 12, it can be seen that the second adjusting sub-circuit 015 in the first driving circuit 01 may include: a third capacitor C3. The light emission control sub-circuit 016 may include: a tenth transistor T10.

One terminal of the third capacitor C3 may be coupled to the first power supply terminal VDD, and the other terminal of the third capacitor C3 may be coupled to the input terminal of the driving sub-circuit 012 (i.e., the first electrode of the eighth transistor T8).

A gate electrode of the tenth transistor T10 may be coupled to the third gate signal terminal GateC, a first electrode of the tenth transistor T10 may be coupled to the first power supply terminal VDD, and a second electrode of the tenth transistor T10 may be coupled to the input terminal of the driving sub-circuit 012 (i.e., the first electrode of the eighth transistor T8).

Fourth, referring to FIGS. 9 to 12, it can be seen that the light emission control circuit 03 shown in FIGS. 5 to 8 may include: an eleventh transistor T11.

A gate electrode of the eleventh transistor T11 may be coupled to the second node P2, a first electrode of the eleventh transistor T11 may be coupled to the first node P1, and a second electrode of the eleventh transistor T11 may be coupled to the light-emitting component L. Optionally, the second electrode of the eleventh transistor T11 may be coupled to the anode of the light-emitting component L.

Optionally, in the pixel circuits shown in FIGS. 9 to 11, the first transistor T1, the second transistor T2 and the third transistor T3 in the digital section may all be N-type transistors. In the pixel circuit shown in FIG. 12, in the digital section, the first transistor T1, the second transistor T2, the fourth transistor T4 and the sixth transistor T6 may all be N-type transistors, while the third transistor T3 and the fifth transistor T5 may both be P-type transistors. In the pixel circuits shown in FIGS. 9 to 12, in the analog section, the ninth transistor T9 and the eleventh transistor T11 may both be N-type transistors, and the seventh transistor T7, the eighth transistor T8, and the tenth transistor T10 may all be P-type transistors. Of course, in some embodiments, the types of the above transistors are not limited to these.

In summary, the embodiments of the present disclosure provide a pixel circuit. The pixel circuit includes: a first driving circuit, a second driving circuit, and a light emission control circuit. The first driving circuit is capable of transmitting a light emission driving signal to a first node based on signals provided by all signal terminals coupled to the first driving circuit; and the second driving circuit is capable of transmitting a light emission control signal having a first potential or a second potential to a second node based on signals provided by all signal terminals coupled to the second driving circuit. A light emission control circuit is capable of controlling switching on and switching off between the first node and a light-emitting component based on the light emission control signal. When the connection between the first node and the light-emitting component is switched on, the light emission driving signal received by the first node may be further transmitted to the light-emitting component to drive the light-emitting component to emit light. The first potential is a high potential relative to the second potential, that is, the first potential is a high potential and the second potential is a low potential. Thus, it can be seen that the light emission control signal not only has characteristics similar to a digital signal but also can provide a preset strobe time for the light-emitting component, namely, control a light emission duration of the light-emitting component. Therefore, driving of the light-emitting component to emit light stably can be ensured, such that display stability of the display panel can be better.

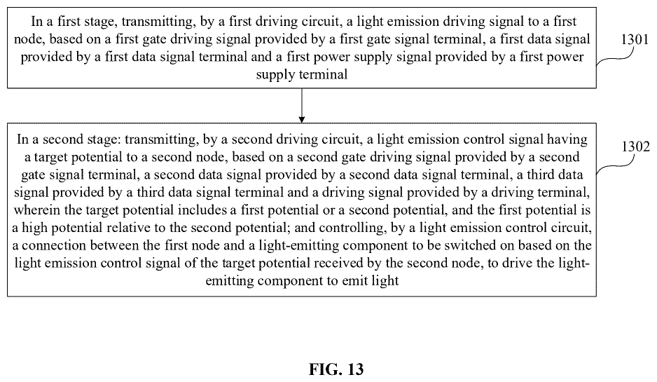

FIG. 13 is a flowchart of a method for driving a pixel circuit according to an embodiment of the present disclosure. The method is applicable to the pixel circuit shown in any one of FIGS. 1 to 12. As shown in FIG. 13, the method includes the following steps.

In 1301, in a first stage, a first driving circuit transmits a light emission driving signal to a first node, based on a first gate driving signal provided by a first gate signal terminal, a first data signal provided by a first data signal terminal and a first power supply signal provided by a first power supply terminal.

In 1302, in a second stage: a second driving circuit transmits a light emission control signal having a target potential to a second node, based on a second gate driving signal provided by a second gate signal terminal, a second data signal provided by a second data signal terminal, a third data signal provided by a third data signal terminal and a driving signal provided by a driving terminal, wherein the target potential includes a first potential or a second potential, and the first potential is a high potential relative to the second potential; and a light emission control circuit controls a connection between the first node and a light-emitting component to be switched on based on the light emission control signal of the target potential received by the second node to drive the light-emitting component to emit light.

A switching-on duration between the first node and the light-emitting component is positively correlated with an uninterrupted duration of the target potential.

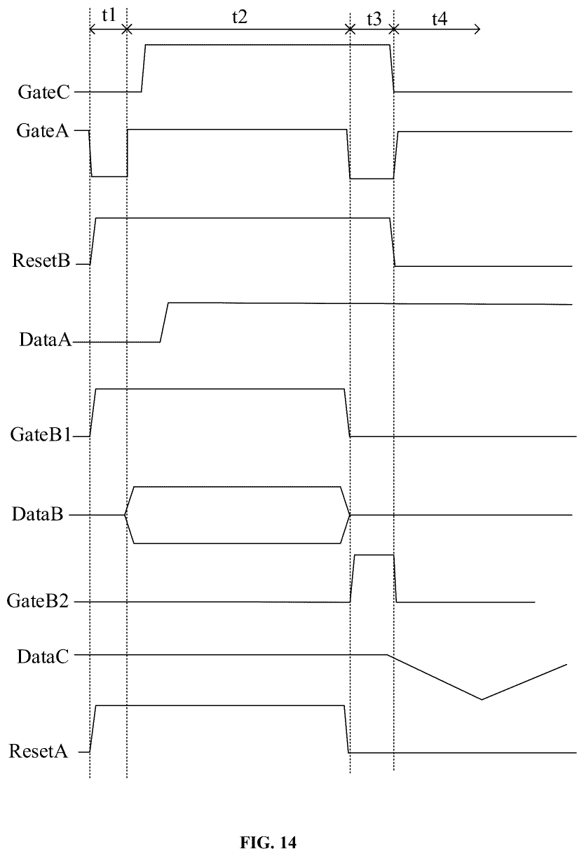

Optionally, taking the structure shown in FIG. 11 as an example, combined with the timing diagram shown in FIG. 14, the working principle of the pixel circuit recorded in the embodiments of the present disclosure is explained as follows.

First, at stage t1:
The potential of the first gate driving signal provided by the first gate signal terminal GateA, the potential of the second sub-gate driving signal provided by the second sub-gate signal terminal GateB2 of the second gate signal terminal GateB, and the potential of the third gate driving signal provided by the third gate signal terminal GateC are all at a low potential. The potential of the first sub-gate driving signal provided by the first sub-gate signal terminal GateB1 of the second gate signal terminal GateB, the potential of the first reset signal provided by the first reset terminal ResetA, and the potential of the second reset signal provided by the second reset terminal ResetB are all at a high potential. Correspondingly, in the analog section, the seventh transistor T7, the ninth transistor T9, and the tenth transistor T10 are all turned on. In the digital section, the first transistor T1 and the third transistor T3 are both turned on, and the second transistor T2 is turned off. Thus, in the analog section, the first data signal provided by the first data signal terminal DataA may be transmitted to the fifth node P5 through the turned-on seventh transistor T7. In addition, in this case, the potential of the first data signal is at a low potential, and correspondingly, the eighth transistor TS in the analog section can be turned on. The second power supply signal provided by the second power supply terminal VSS may be transmitted to the first node P1 through the turned-on ninth transistor T9. The first power supply signal provided by the first power supply terminal VDD may be transmitted to the first electrode of the eighth transistor T8 through the turned-on tenth transistor T10. In the digital section, the second data signal provided by the second data signal terminal DataB may be transmitted to the third node P3 through the turned-on first transistor T1, and in this case, the potential of the second data signal is at a low potential. Under the coupling action of the first capacitor C1, this low-potential second data signal may be further written into the fourth node P4. The connection between the second node P2 and the fourth node P4 is switched on, and the low potential of the fourth node P4 may be further transmitted to the second node P2 through the turned-on third transistor T3. That is, in this case, both the input terminal and the output terminal of the inverter F1 may be set to low, and correspondingly, the eleventh transistor T11 in the analog section is turned off.

Then, at stage t2:
The potential of the second sub-gate driving signal provided by the second sub-gate signal terminal GateB2 of the second gate signal terminal GateB is at a low potential. The potential of the first gate driving signal provided by the first gate signal terminal GateA, the potential of the first sub-gate driving signal provided by the first sub-gate signal terminal GateB1 of the second gate signal terminal GateB, the potential of the third gate driving signal provided by the third gate signal terminal GateC, the potential of the first reset signal provided by the first reset terminal ResetA, and the potential of the second reset signal provided by the second reset terminal ResetB are all at a high potential. Correspondingly, in the analog section, the ninth transistor T9 is turned on, and the seventh transistor T7 and the tenth transistor T10 are both turned off. In the digital section, the first transistor T1 and the third transistor T3 are both turned on, and the second transistor T2 is turned off. Thus, in the analog section, the fifth node P5 is floating. Under the coupling action of the second capacitor C2 and the third capacitor C3, the threshold voltage Vth of the eighth transistor T8 can be read and written into the fifth node P5 (i.e., the gate electrode of the eighth transistor T8). The second power supply signal provided by the second power supply terminal VSS may continue to be transmitted to the first node P1 through the turned-on ninth transistor T9. In the digital section, the second data signal provided by the second data signal terminal DataB may continue to be transmitted to the third node P3 through the turned-on first transistor T1. Under the coupling action of the first capacitor C1, the potential of the fourth node P4 may change with the change of the potential of the third node P3. The connection between the second node P2 and the fourth node P4 is switched on, and the signal written into the fourth node P4 may be further transmitted to the second node P2 through the turned-on third transistor T3.

Then, at stage t3:
The potential of the first gate driving signal provided by the first gate signal terminal GateA, the potential of the first sub-gate driving signal provided by the first sub-gate signal terminal GateB1 of the second gate signal terminal GateB, and the potential of the first reset signal provided by the first reset terminal ResetA are all at a low potential. The potential of the second sub-gate driving signal provided by the second sub-gate signal terminal GateB2 of the second gate signal terminal GateB, the potential of the third gate driving signal provided by the third gate signal terminal GateC, and the potential of the second reset signal provided by the second reset terminal ResetB are all at a high potential. Correspondingly, in the analog section, the seventh transistor T7 and the ninth transistor T9 are both turned on, and the tenth transistor T10 is turned off. In the digital section, the second transistor T2 is turned on, and the first transistor T1 and the third transistor T3 are both turned off. Thus, in the analog section, the first data signal provided by the first data signal terminal DataA may be transmitted to the fifth node P5 through the turned-on seventh transistor T7, achieving the writing of the data signal. The second power supply signal provided by the second power supply terminal VSS may continue to be transmitted to the first node P1 through the turned-on ninth transistor T9. In the digital section, the third data signal provided by the third data signal terminal DataC may be transmitted to the third node P3 through the turned-on second transistor T2. Under the coupling action of the first capacitor C1, the potential of the fourth node P4 may change with the change of the potential of the third node P3. The second node P2 may be decoupled from the fourth node P4.

Finally, at stage t4:
The potential of the third gate driving signal provided by the third gate signal terminal GateC, the potential of the first sub-gate driving signal provided by the first sub-gate signal terminal GateB1 of the second gate signal terminal GateB, the potential of the second sub-gate driving signal provided by the second sub-gate signal terminal GateB2 of the second gate signal terminal GateB, the potential of the first reset signal provided by the first reset terminal ResetA, and the potential of the second reset signal provided by the second reset terminal ResetB are all at a low potential. The potential of the first gate driving signal provided by the first gate signal terminal GateA is at a high potential. Correspondingly, in the analog section, the seventh transistor T7, the ninth transistor T9, and the tenth transistor T10 are all turned off. In the digital section, the second transistor T2 is turned on, and the first transistor T1 and the third transistor T3 are both turned off. Moreover, under the storage action of the second capacitor C2, the fifth node P5 may maintain the potential provided in the previous stage, and the eighth transistor T8 is turned on. Thus, in the analog section, the first power supply signal provided by the first power supply terminal VDD may be transmitted to the first electrode of the eighth transistor T8 through the turned-on tenth transistor T10. The eighth transistor T8 may, based on the signal at the gate electrode (i.e., the fifth node P5) and the first power supply signal received by the first electrode, generate a light emission driving signal, and transmit the generated signal to the first node P1. In the digital section, the third data signal provided by the third data signal terminal DataC may continue to be transmitted to the third node P3 through the turned-on second transistor T2. Under the coupling action of the first capacitor C1, the potential of the fourth node P4 may change with the change of the potential of the third node P3. The second node P2 may be decoupled from the fourth node P4.

When the potential of the second node P2 is at a high potential, the eleventh transistor T11 in the analog section may be switched on, such that the light emission driving signal transmitted to the first node Pl is further transmitted to the light-emitting component L through the turned-on eleventh transistor T11, thereby driving the light-emitting component L to emit light. When the potential of the second node P2 is at a low potential, the eleventh transistor T11 in the analog section may be turned off, such that the light emission driving signal transmitted to the first node Pl cannot be further transmitted to the light-emitting component L, thereby preventing the light-emitting component L from emitting light. Thus, it can be seen that the duration for which the potential of the second node P2 (i.e., the potential of the light emission control signal) is at a high potential can determine the light emission duration of the light-emitting component L, and the two are positively correlated.

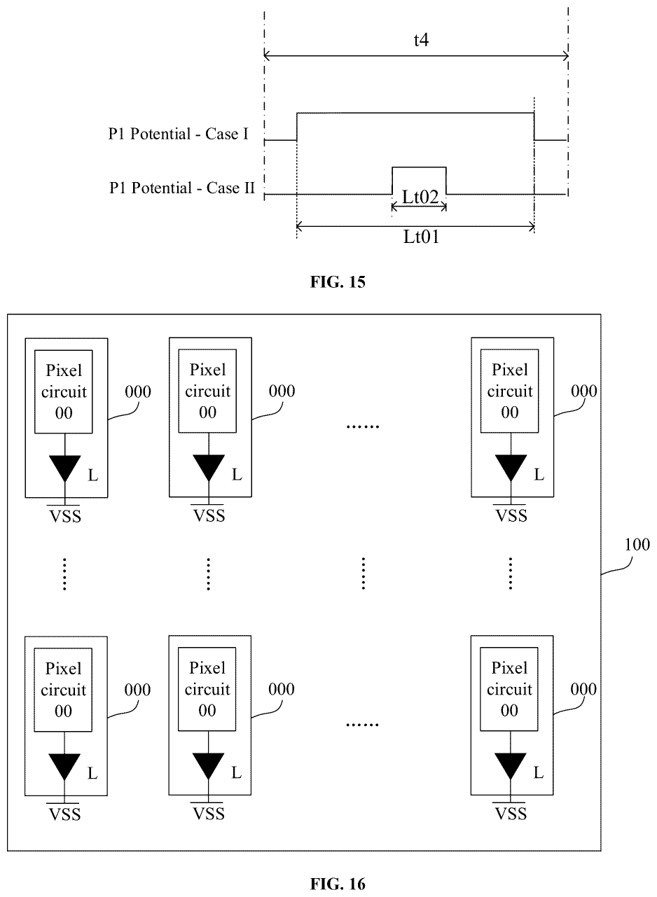

Based on the above working principle, the principle of controlling the potential of the second node P2 in the digital section is further explained in combination with FIG. 15.

At stage t2, since the first transistor T1 and the third transistor T3 are both turned on and the second transistor T2 is turned off, the second data signal provided by the second data signal terminal DataB may be transmitted to the third node P3, and the connection between the second node P2 and the fourth node P4 is switched on. The voltage at the input terminal of the inverter F1 (i.e., the fourth node P4) and the potential at the output terminal (i.e., the second node P2) are equal. Assuming that the potential of the fourth node P4 is Vp4=Vc (i.e., the potential of the second node P2 is Vp2=Vc), and the potential of the second data signal transmitted to the third node P3 is VdataB, i.e., the potential of the third node P3 is Vp3=VdataB, during in this first cycle, it can be seen that the voltage difference across the first capacitor C1 may be: Vp3−Vp4 =VdataB−Vc.

At stage t4, since the second transistor T2 is turned on and the first transistor T1 and the third transistor T3 are both turned off, the third data signal provided by the third data signal terminal DataC can be transmitted to the third node P3, and the second node P2 is decoupled from the fourth node P4. Under the coupling action of the first capacitor C1, the potential of the fourth node P4 changes with the change of the potential of the third node P3. Assuming that the potential of the third data signal transmitted to the third node P3 is VdataC, that is, the potential of the third node P3 is Vp3=VdataC, in this second cycle, it can be seen that the potential Vp4 of the fourth node P4 may satisfy: Vp4=VdataC−(VdataB−Vc). Thus, it can be seen that under the premise that the amplitude of VdataC varies with time, the potential of the fourth node P4 can also change over time at the same rate.

Referring to FIG. 15, it can be seen that if VdataC<VdataB, then Vp4<Vc (i.e., Vp2). In this case, at the above stage t4, the output terminal of the inverter F1 may output a light emission control signal at a high potential to enable the eleventh transistor T11 to be turned on, such that the light emission driving signal transmitted to the first node P1 can be transmitted to the light-emitting component L through the turned-on eleventh transistor T11, allowing the light-emitting component L to be driven by a constant current to emit light. If VdataC>VdataB, then Vp4>Vc (i.e., Vp2). In this case, at the above stage 14, the output terminal of the inverter F1 may output a light emission control signal at a low potential to enable the eleventh transistor T11 to be turned off. This in turn prevents the light emission driving signal transmitted to the first node P1 from being transmitted to the light-emitting component L, such that the light-emitting component L cannot emit light and remains in a dark state.

In some embodiments, in the case that the waveform of VdataC is fixed, the longer the duration for which VdataB is greater than VdataC, the longer the uninterrupted duration for which the potential of the light emission control signal output by the output terminal of the inverter F1 is at a high potential, and thus the longer the light emission duration Lt of the light-emitting component L. The shorter the duration for which VdataB is greater than VdataC, the shorter the uninterrupted duration for which the potential of the light emission control signal output by the output terminal of the inverter F1 is at a high potential, and thus the shorter the light emission duration Lt of the light-emitting component L. Referring to FIG. 15, it can be seen that in case I compared to case II, the amplitude of VdataB is larger. Thus, at stage t4, the duration for which VdataB is greater than VdataC is longer, that is, the time length for which the potential of P1 is at a high level is longer, and Lt02>Lt01.

Based on the above embodiments, it can be seen that the present disclosure provides a pixel circuit including a digital section and an analog section. The analog section may be configured to generate a driving current (i.e., the light emission driving signal), and the digital section may provide a strobe time (i.e., the light emission control signal) to control the time and the uninterrupted duration for which the driving current is transmitted to the light-emitting component L, thereby achieving different levels of light emission luminance, and further enabling the display panel to display different display gray scales. This pixel circuit is beneficial for use in scenarios requiring lower gray scale levels.

In summary, the embodiments of the present disclosure provide a method for driving a pixel circuit. In this method, the first driving circuit is capable of transmitting a light emission driving signal to a first node based on signals provided by all signal terminals coupled to the first driving circuit; and the second driving circuit is capable of transmitting a light emission control signal having a first potential or a second potential to a second node based on signals provided by all signal terminals coupled to the second driving circuit. A light emission control circuit is capable of controlling switching on and switching off between the first node and a light-emitting component based on the light emission control signal. When connection between the first node and the light-emitting component is switched on, the light emission driving signal received by the first node may be further transmitted to the light-emitting component to drive the light-emitting component to emit light. The first potential is a high potential relative to the second potential, that is, the first potential is a high potential and the second potential is a low potential. Thus, it can be seen that the light emission control signal not only has characteristics similar to a digital signal but also can provide a preset strobe time for the light-emitting component, namely, control a light emission duration of the light-emitting component. Therefore, driving of the light-emitting component to emit light stably can be ensured, such that display stability of the display panel can be better.

FIG. 16 is a schematic structural diagram of a display panel according to an embodiment of the present disclosure. As shown in FIG. 16, the display panel includes: a substrate 100, and a plurality of pixels 000 disposed on one side of the substrate 10. Optionally, the material of the substrate 100 may be any one of silicon, quartz, glass, plastic or polyimide, and the substrate may be used in head-mounted or handheld display products.

Each pixel 000 may include: a light-emitting component L, and the pixel circuit 00 as shown in any one of FIGS. 1 to 12. In addition, the pixel circuit 00 is coupled to the light-emitting component L and is configured to drive the light-emitting component L to emit light.

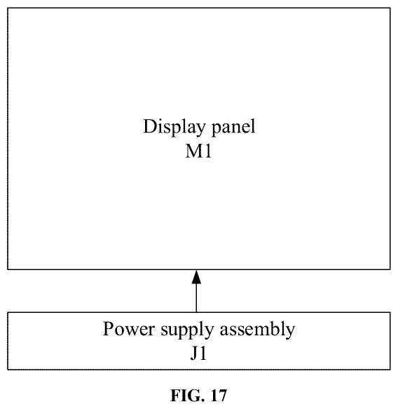

FIG. 17 is a schematic structural diagram of a display device according to an embodiment of the present disclosure. As shown in FIG. 17, the display apparatus includes: a power supply assembly J1, and the display panel M1 as shown in FIG. 16.

The power supply assembly J1 is coupled to the display panel M1 and is configured to supply power to the display panel M1.

Optionally, the display apparatus recorded in the embodiments of the present disclosure may be any product or component having a display function, such as a mobile phone, a tablet computer, a television and a display.

It should be noted that the terms used in the embodiments of the present disclosure are used for explaining the present embodiments, rather than being intended to limit the present disclosure. Unless otherwise defined, the technical terms or scientific terms used in the implementations of the present disclosure shall be taken to mean the ordinary meanings as understood by the ordinary skill in the art to which the present disclosure belongs.

For example, in the embodiments of the present disclosure, the terms “first” and “second” are only used for a descriptive purpose, and shall not be understood as indicating or implying relative importance. Unless otherwise expressly defined, the term “a plurality of” means two or more.

Similarly, terms such as “a” or “one” do not indicate the quantity limit, but indicate the existence of at least one.

The terms “comprise/include” or “contain” and the like are intended to mean that the elements or objects before the terms cover the elements or objects or equivalents listed after the terms, without excluding other elements or objects.

The terms “upper”, “lower”, “left” or “right”, and the like are only used to indicate the relative positional relations; and after the absolute position of the described object changes, the relative positional relationship may also change accordingly.

The foregoing descriptions are merely optional embodiments of the present disclosure, and are not intended to limit the present disclosure. Within the spirit and principles of the present disclosure, any modifications, equivalent substitutions, improvements, etc., are within the protection scope of the present disclosure.

1. A pixel circuit, comprising:
a first driving circuit, connected to a first gate signal terminal, a first data signal terminal, a first power supply terminal and a first node, respectively, and configured to, based on a first gate driving signal provided by the first gate signal terminal, a first data signal provided by the first data signal terminal and a first power supply signal provided by the first power supply terminal, transmit a light emission driving signal to the first node;
a second driving circuit, connected to a second gate signal terminal, a second data signal terminal, a third data signal terminal, a driving terminal and a second node, respectively, and configured to, based on a signal second gate driving signal provided by the second gate signal terminal, a second data signal provided by the second data signal terminal, a third data signal provided by the third data signal terminal and a driving signal provided by the driving terminal, transmit a light emission control signal having a first potential or a second potential to the second node, wherein the first potential is a high potential relative to the second potential; and
a light emission control circuit, connected to the first node, the second node and a light-emitting component, respectively, and configured to control switching on and switching off between the first node and the light-emitting component based on the light emission control signal from the second node.

2. The pixel circuit according to claim 1, wherein the second driving circuit comprises:
a switching sub-circuit, connected to the second gate signal terminal, the second data signal terminal, the third data signal terminal and a third node, respectively, and configured to, based on the second gate driving signal, control switching on and switching off between the second data signal terminal and the third node, and control switching on and switching off between the third data signal terminal and the third node; and
an outputting sub-circuit, connected to the third node, the driving terminal and the second node, respectively, and configured to transmit the light emission control signal to the second node based on the driving signal and a potential of the third node.

3. The pixel circuit according to claim 2, wherein the driving terminal comprises a first reset terminal; and the second gate signal terminal comprises a first sub-gate signal terminal and a second sub-gate signal terminal;
the switching sub-circuit comprises:
a first switching unit, connected to the first sub-gate signal terminal, the second data signal terminal and the third node, respectively, and configured to control switching on and switching off between the second data signal terminal and the third node based on a first sub-gate driving signal provided by the first sub-gate signal terminal;
a second switching unit, connected to the second sub-gate signal terminal, the third data signal terminal and the third node, respectively, and configured to control switching on and switching off between the third data signal terminal and the third node based on a second sub-gate driving signal provided by the second sub-gate signal terminal; and
the outputting sub-circuit comprises:
an adjusting unit, connected to the third node and a fourth node, respectively, and configured to adjust a potential of the fourth node based on the potential of the third node;
an inverting unit, connected to the fourth node and the second node, respectively, and configured to perform potential inversion on a signal of the fourth node and transmit the inverted signal as the light emission control signal to the second node; and
a third switching unit, connected to the first reset terminal, the fourth node and the second node, respectively, and configured to control switching on and switching off between the fourth node and the second node based on a first reset signal provided by the first reset terminal.

4. The pixel circuit according to claim 3, wherein the first switching unit comprises a first transistor; the second switching unit comprises a second transistor; the adjusting unit comprises a first capacitor; the inverting unit comprises an inverter; and the third switching unit comprises a third transistor;
a gate electrode of the first transistor is connected to the first sub-gate signal terminal, a first electrode of the first transistor connected to the second data signal terminal, and a second electrode of the first transistor is connected to the third node;
a gate electrode of the second transistor is connected to the second sub-gate signal terminal, a first electrode of the second transistor is connected to the third data signal terminal, and a second electrode of the second transistor is connected to the third node;
one terminal of the first capacitor is connected to the third node, and the other terminal of the first capacitor is connected to the fourth node;
an input terminal of the inverter is connected to the fourth node, and an output terminal of the inverter is connected to the second node; and
a gate electrode of the third transistor is connected to the first reset terminal, a first electrode of the third transistor is connected to the fourth node, and a second electrode of the third transistor is connected to the second node.

5. The pixel circuit according to claim 2, wherein the driving terminal comprises the first power supply terminal and a second power supply terminal; and the third node comprises a first sub-node and a second sub-node;
the switching sub-circuit comprises:
a first switching unit, connected to the second gate signal terminal, the second data signal terminal and the first sub-node, respectively, and configured to control switching on and switching off between the second data signal terminal and the first sub-node based on the second gate driving signal; and
a second switching unit, connected to the second gate signal terminal, the third data signal terminal and the second sub-node, respectively, and configured to control switching on and switching off between the third data signal terminal and the second sub-node based on the second gate driving signal;
and, the outputting sub-circuit comprises:
two output units, wherein one of the output units is connected to the first sub-node, the first power supply terminal, the second power supply terminal and the second node, respectively, and the other output unit is connected to the second sub-node, the first power supply terminal, the second power supply terminal and the second node, respectively, and the two output units are configured to, based on a potential of the first sub-node, a potential of the second sub-node, the first power supply signal, and a second power signal provided by the second power supply terminal, transmit the light emission control signal to the second node.

6. The pixel circuit according to claim 5, wherein the first switching unit comprises a first transistor; the second switching unit comprises a second transistor; in the two output units, one output unit comprises a third transistor and a fourth transistor that have different types, and the other output unit comprises a fifth transistor and a sixth transistor that have different types;
a gate electrode of the first transistor is connected to the second gate signal terminal, a first electrode of the first transistor is connected to the second data signal terminal, and a second electrode of the first transistor is connected to the first sub-node;
a gate electrode of the second transistor is connected to the second gate signal terminal, a first electrode of the second transistor is connected to the third data signal terminal, and a second electrode of the second transistor is connected to the second sub-node;
a gate electrode of the third transistor and a gate electrode of the fourth transistor are both connected to the first sub-node and the second node, a first electrode of the third transistor is connected to the first power supply terminal, a first electrode of the fourth transistor is connected to the second power supply terminal, and a second electrode of the third transistor and a second electrode of the fourth transistor are both connected to the second sub-node; and
a gate electrode of the fifth transistor and a gate electrode of the sixth transistor are both connected to the second sub-node and the second node, a first electrode of the fifth transistor connected to the first power supply terminal, a first electrode of the sixth transistor is connected to the second power supply terminal, and a second electrode of the fifth transistor and a second electrode of the sixth transistor are both connected to the first sub-node.

7. The pixel circuit according to claim 1, wherein the first driving circuit is further connected to a second reset terminal and a second power supply terminal, respectively, and is configured to control switching on and switching off between the second power supply terminal and the first node based on a second reset signal provided by the second reset terminal; and
the first driving circuit comprises:
a data writing sub-circuit, connected to the first gate signal terminal, the first data signal terminal and a fifth node, respectively, and configured to control switching on and switching off between the first data signal terminal and the fifth node based on the first gate driving signal;
a driving sub-circuit, wherein the driving sub-circuit has an input terminal connected to the first power supply terminal, a driving terminal connected to the fifth node, and an output terminal connected to the first node, and the driving sub-circuit is configured to transmit the light emission driving signal to the first node based on the first power supply signal and a potential of the fifth node; and
a reset sub-circuit, connected to the second reset terminal, the second power supply terminal and the first node, respectively, and configured to control switching on and switching off between the second power supply terminal and the first node based on the second reset signal.

8. The pixel circuit according to claim 7, wherein the data writing sub-circuit comprises a seventh transistor; the driving sub-circuit comprises an eighth transistor; the reset sub-circuit comprises a ninth transistor;
a gate electrode of the seventh transistor is connected to the first gate signal terminal, a first electrode of the seventh transistor is connected to the first data signal terminal, and a second electrode of the seventh transistor is connected to the fifth node;
a gate electrode of the eighth transistor connected to the fifth node, a first electrode of the eighth transistor is connected to the first power supply terminal, and a second electrode of the eighth transistor is connected to the first node; and
a gate electrode of the ninth transistor is connected to the second reset terminal, a first electrode of the ninth transistor is connected to the second power supply terminal, and a second electrode of the ninth transistor is connected to the first node.

9. The pixel circuit according to claim 7, wherein the first driving circuit further comprises:
a first adjusting sub-circuit, connected to the fifth node and a target terminal, respectively, and configured to adjust the potential of the fifth node based on a potential of the target terminal;
and, the target terminal comprises: a reference power supply terminal, the first node, or an input terminal of the driving sub-circuit.

10. The pixel circuit according to claim 9, wherein the first adjusting sub-circuit comprises a second capacitor; the second adjusting sub-circuit comprises a third capacitor; the light emission control sub-circuit comprises a tenth transistor;
one terminal of the second capacitor is connected to the target terminal, and the other terminal of the second capacitor is connected to the fifth node;
one terminal of the third capacitor is connected to the first power supply terminal, and the other terminal of the third capacitor is connected to the input terminal of the driving sub-circuit; and
a gate electrode of the tenth transistor is connected to the third gate signal terminal, a first electrode of the tenth transistor is connected to the first power supply terminal, and a second electrode of the tenth transistor is connected to the input terminal of the driving sub-circuit.

11. The pixel circuit according to claim 9, wherein the target terminal is the reference power supply terminal, and the transistor comprised in the data writing sub-circuit is a transmission gate switching transistor.

12. The pixel circuit according to claim 1, wherein the light emission control circuit comprises an eleventh transistor; and
a gate electrode of the eleventh transistor is connected to the second node, a first electrode of the eleventh transistor connected to the first node, and a second electrode of the eleventh transistor is connected to the light-emitting component.

13. A method for driving the pixel circuit according to claim 1, wherein the method comprises:
in a first stage, transmitting, by the first driving circuit, the light emission driving signal to the first node, based on a the first gate driving signal provided by the first gate signal terminal, the first data signal provided by the first data signal terminal and the first power supply signal provided by the first power supply terminal; and
in a second stage: transmitting, by the second driving circuit, the light emission control signal having a target potential to the second node, based on the second gate driving signal provided by the second gate signal terminal, the second data signal provided by the second data signal terminal, the third data signal provided by the third data signal terminal and the driving signal provided by the driving terminal, wherein the target potential comprises a first potential or a second potential, and the first potential is a high potential relative to the second potential; and controlling, by the light emission control circuit, the connection between the first node and the light-emitting component to be switched on based on the light emission control signal of the target potential from the second node, to drive the light-emitting component to emit light, wherein a switching-on duration between the first node and the light-emitting component is positively correlated with an uninterrupted duration of the target potential.

14. A display panel, comprising: a substrate, and a plurality of pixels disposed on one side of the substrate,
wherein each pixel comprises a light-emitting component and a pixel circuit; the pixel circuit is connected to the light-emitting component and is configured to drive the light-emitting component to emit light; and the pixel circuit comprises:
a first driving circuit, connected to a first gate signal terminal, a first data signal terminal, a first power supply terminal and a first node, respectively, and configured to, based on a first gate driving signal provided by the first gate signal terminal, a first data signal provided by the first data signal terminal and a first power supply signal provided by the first power supply terminal, transmit a light emission driving signal to the first node;
a second driving circuit, connected to a second gate signal terminal, a second data signal terminal, a third data signal terminal, a driving terminal and a second node, respectively, and configured to, based on a second gate driving signal provided by the second gate signal terminal, a second data signal provided by the second data signal terminal, a third data signal provided by the third data signal terminal and a driving signal provided by the driving terminal, transmit a light emission control signal having a first potential or a second potential to the second node, wherein the first potential is a high potential relative to the second potential; and
a light emission control circuit, connected to the first node, the second node and a light-emitting component, respectively, and configured to control switching on and switching off between the first node and the light-emitting component based on the light emission control signal from the second node.

15. A display apparatus, comprising: a power supply assembly, and the display panel according to claim 14,
wherein the power supply assembly connected to the display panel and is configured to supply power to the display panel.

16. The pixel circuit according to claim 7, wherein the first driving circuit further comprises:
a first adjusting sub-circuit, coupled connected to the fifth node and an input terminal of the driving sub-circuit, respectively, and configured to adjust the potential of the fifth node based on a potential of the input terminal of the driving sub-circuit;
a second adjusting sub-circuit, connected to the first power supply terminal and the input terminal of the driving sub-circuit, respectively, and configured to adjust a potential of the input terminal of the driving sub-circuit based on the first power supply signal; and
a light emission control sub-circuit, connected to a third gate signal terminal, the first power supply terminal and the input terminal of the driving sub-circuit, respectively, and configured to control switching on and switching off between the first power supply terminal and the input terminal of the driving sub-circuit based on a third gate driving signal provided by the third gate signal terminal.

17. The display panel according to claim 14, wherein the second driving circuit comprises:
a switching sub-circuit, connected to the second gate signal terminal, the second data signal terminal, the third data signal terminal and a third node, respectively, and configured to, based on the second gate driving signal, control switching on and switching off between the second data signal terminal and the third node, and control switching on and switching off between the third data signal terminal and the third node; and
an outputting sub-circuit, connected to the third node, the driving terminal and the second node, respectively, and configured to transmit the light emission control signal to the second node based on the driving signal and a potential of the third node.

18. The display panel according to claim 17, wherein the driving terminal comprises a first reset terminal; and the second gate signal terminal comprises a first sub-gate signal terminal and a second sub-gate signal terminal;
the switching sub-circuit comprises:
a first switching unit, connected to the first sub-gate signal terminal, the second data signal terminal and the third node, respectively, and configured to control switching on and switching off between the second data signal terminal and the third node based on a first sub-gate driving signal provided by the first sub-gate signal terminal;
a second switching unit, connected to the second sub-gate signal terminal, the third data signal terminal and the third node, respectively, and configured to control switching on and switching off between the third data signal terminal and the third node based on a second sub-gate driving signal provided by the second sub-gate signal terminal; and
the outputting sub-circuit comprises:
an adjusting unit, connected to the third node and a fourth node, respectively, and configured to adjust a potential of the fourth node based on the potential of the third node;
an inverting unit, connected to the fourth node and the second node, respectively, and configured to perform potential inversion on a signal of the fourth node and transmit the inverted signal as the light emission control signal to the second node; and
a third switching unit, connected to the first reset terminal, the fourth node and the second node, respectively, and configured to control switching on and switching off between the fourth node and the second node based on a first reset signal provided by the first reset terminal.

19. The display panel according to claim 18, wherein the first switching unit comprises a first transistor; the second switching unit comprises a second transistor; the adjusting unit comprises a first capacitor; the inverting unit comprises an inverter; and the third switching unit comprises a third transistor;
a gate electrode of the first transistor is connected to the first sub-gate signal terminal, a first electrode of the first transistor is connected to the second data signal terminal, and a second electrode of the first transistor is connected to the third node;
a gate electrode of the second transistor is connected to the second sub-gate signal terminal, a first electrode of the second transistor is connected to the third data signal terminal, and a second electrode of the second transistor is connected to the third node;
one terminal of the first capacitor is connected to the third node, and the other terminal of the first capacitor is connected to the fourth node;
an input terminal of the inverter is connected to the fourth node, and an output terminal of the inverter is connected to the second node; and
a gate electrode of the third transistor is connected to the first reset terminal, a first electrode of the third transistor is connected to the fourth node, and a second electrode of the third transistor is connected to the second node.

20. The display panel according to claim 17, wherein the driving terminal comprises the first power supply terminal and a second power supply terminal; and the third node comprises a first sub-node and a second sub-node;
the switching sub-circuit comprises:
a first switching unit, connected to the second gate signal terminal, the second data signal terminal and the first sub-node, respectively, and configured to control switching on and switching off between the second data signal terminal and the first sub-node based on the second gate driving signal; and
a second switching unit, connected to the second gate signal terminal, the third data signal terminal and the second sub-node, respectively, and configured to control switching on and switching off between the third data signal terminal and the second sub-node based on the second gate driving signal;
and, the outputting sub-circuit comprises:
two output units, wherein one of the output units is connected to the first sub-node, the first power supply terminal, the second power supply terminal and the second node, respectively, and the other output unit is connected to the second sub-node, the first power supply terminal, the second power supply terminal and the second node, respectively, and the two output units are configured to, based on a potential of the first sub-node, a potential of the second sub-node, the first power supply signal, and a second power signal provided by the second power supply terminal, transmit the light emission control signal to the second node.
